(19) United States
(12) Patent Application Publication
(10) Pub. No.: US 2021/0125299 A1
(43) Pub. Date: Apr. 29, 2021

(54) INFORMATION PROCESSING APPARATUS, INFORMATION PROCESSING SYSTEM, AND INFORMATION PROCESSING METHOD

(71) Applicant: TOYOTA JIDOSHA KABUSHIKI KAISHA, Toyota-shi (JP)

(72) Inventors: Yuki NAKANO, Nisshin-shi (JP); Masato URA, Nisshin-shi (JP); Koji TAKAO, Toyota-shi (JP); Hideyuki SAKURAI, Toyota-shi (JP); Keisuke HOTTA, Miyoshi-shi (JP); Rieko MASUTANI, Toyota-shi (JP); Atsushi HANAWA, Miyoshi-shi (JP); Masanobu OHMI, Kasugai-shi (JP); Takashi HAYASHI, Nagoya-shi (JP); Atsushi NABATA, Nagakute-shi (JP); Tetsuro SAKAGUCHI, Toyota-shi (JP)

(73) Assignee: TOYOTA JIDOSHA KABUSHIKI KAISHA, Toyota-shi (JP)

(21) Appl. No.: 17/078,207

(22) Filed: Oct. 23, 2020

(30) Foreign Application Priority Data
Oct. 28, 2019 (JP) 2019-195492

(51) Int. Cl. G06Q 50/28; G06Q 10/06; G06Q 20/14; G06Q 30/02; G06Q 30/06

(52) U.S. Cl. CPC G06Q 50/28; G06Q 10/06315; B60P 9/00; G06Q 30/0284; G06Q 30/0645; G06Q 20/145

(57) ABSTRACT

To effectively utilize user's belongings that are not being used. The information processing apparatus includes a processor configured to: determine, when a use request is received from a second user for a room unit in which a first user stores at least one of the first user's belongings as a storeroom, a transport unit that connects to the room unit and transports the room unit to a designated place by the second user; and cause the transport unit connected to the room unit to move to the designated place by the second user and to separate from the room unit at the designated place by the second user.

### CROSS REFERENCE TO RELATED APPLICATION

This application claims the benefit of Japanese Patent Application No. 2019-195492, filed on Oct. 28, 2019, which is hereby incorporated by reference herein in its entirety.

### BACKGROUND

### Technical Field

The present disclosure relates to an information processing apparatus, an information processing system, and an information processing method.

### Description of the Related Art

There has been disclosed to provide a mobile lesson-room vehicle by loading a music instrument on a vehicle and setting it in a compartment (for example, Patent document 1).

### CITATION LIST

### Patent Document

Patent document 1: Japanese Patent Laid-Open No. 2001-277932

An aspect of the disclosure is to provide an information processing apparatus, an information processing system, and an information processing method capable of effectively utilizing articles that are not being used.

### SUMMARY

One aspect of the present disclosure is an information processing apparatus, comprising a processor configured to:

determine, when a use request is received from a second user for a room unit in which a first user stores at least one of the first user's belongings as a storeroom, a transport unit that connects to the room unit and transports the room unit to a designated place by the second user; and

cause the transport unit connected to the room unit to move to the designated place by the second user and to separate from the room unit at the designated place by the second user.

Further, another aspect of the present disclosure is an information processing system, comprising a processor configured to:

determine, when a use request is received from a second user for a room unit in which a first user stores at least one of the first user's belongings as a storeroom, a transport unit that connects to the room unit and transports the room unit to a designated place by the second user; and

cause the transport unit connected to the room unit to move to the designated place by the second user and to separate from the room unit at the designated place by the second user.

Further, another aspect of the present disclosure is an information processing method executed by a computer, comprising:

determining, when a use request is received from a second user for a room unit in which a first user stores at least one of the first user's belongings as a storeroom, a transport unit that connects to the room unit and transports the room unit to a designated place by the second user; and

causing the transport unit connected to the room unit to move to the designated place by the second user and to separate from the room unit at the designated place by the second user.

According to the present disclosure, it is possible to effectively utilize the articles that are not being used.

### BRIEF DESCRIPTION OF DRAWINGS

FIG. 1 is a diagram illustrating an example of a system configuration of a mobile rental-room providing system according to a first embodiment;

FIG. 2 is a diagram illustrating an example of a separable vehicle;

FIG. 3 is a diagram illustrating an example of a hardware configuration of a traveling unit;

FIG. 4 is a diagram illustrating an example of specifications of a room unit;

FIG. 5 is a diagram illustrating an example of a hardware configuration of a center server according to the first embodiment;

FIG. 6 is a diagram illustrating an example of a functional configuration of a center server, a vehicle management server, and a storeroom management server in the mobile rental-room providing system;

FIG. 7 is an example of a traveling unit information table;

FIG. 8 is an example of a room unit information table;

FIG. 9 is an example of a schedule information table;

FIG. 10 is an example of a flowchart of the processing of the center server, when a use request for the room unit is received;

FIG. 11 is a flowchart of the processing of the center server 1 when delivering the room unit;

FIG. 12 is an example of a flowchart of the processing when the center server receives a use end notification;

FIG. 13 is a chart illustrating an example of a sequence of the processing of the mobile rental-room providing system from transmission of a use request of the room unit from the user terminal until generation of a schedule for providing the room unit;

FIG. 14 is a chart illustrating a sequence of the processing when delivering the room unit to the designated place of the user; and

FIG. 15 is a chart illustrating an example of a sequence of pickup processing of the room unit executed in the mobile rental-room providing system.

### DESCRIPTION OF THE EMBODIMENTS

An aspect of the present disclosure is an information processing apparatus that includes a processor configured to: when a use request is received from a second user for a room unit in which a first user stores at least one of the first user's belongings as a storeroom, determine a transport unit that connects to the room unit and transports the room unit to a designated place by the second user; and cause the transport unit connected to the room unit to move to the designated place by the second user and to separate from the room unit at the designated place by the second user. The information processing apparatus may include one processor or more.

The transport unit is a traveling unit that includes a plurality of wheels and a drive unit that drives the wheels, for example. However, the transport unit is not limited to that but may also be a flying body such as a drone having a propeller. The transport unit and the room unit may be connectable and separable, for example. By connecting the transport unit and the room unit, it becomes possible to function as an automobile or an aircraft capable of loading and carrying people or things, for example.

The room unit has a room space including an entrance, a window, a chair, and the like, for example. Examples of the first user's belongings to be stored in the room unit may be instruments such as music instruments, training machines, game machines, household electric machines and karaoke machines, and furniture such as lockers and sofas. Examples of the music instruments to be stored in the room unit may be a piano, a violin, a trumpet, and the like. Examples of the household electric machines provided in the room unit may be a television set, audio equipment, a projector, a DVD/Blu-Ray® player, a speaker, and the like. The room unit with a single or a plurality of such the first user's belongings provided therein can be used, for example, as a lesson room for a music instrument, a training room, a game room, a karaoke room, a party room, or a relaxing room where a massage chair is placed.

In the aspect of the present disclosure, the transport unit connected to the room unit as described above moves to the designated place by the second user in response to the use request from the second user, and separates the room unit. That is, according to the aspect of the present disclosure, it is possible to achieve a service that provides the room unit serving as a storeroom including at least one of the first user's belonging stored therein to the designated place by the user who uses the room unit as a rental room having predetermined equipment.

For example, the first user's belonging to be stored in the room unit as the storeroom is highly probable to be a thing which the first user does not use any more. According to the aspect of the present disclosure, by renting such belonging to the second user, the belonging which the first user does not use any more can be effectively utilized. Further, according to the aspect of the present disclosure, the room unit can have two functions as the storeroom and a rental room, so that the room unit can be effectively utilized.

Further, the transport unit and the room unit can be connected and separated. Also, while the room unit is being used, there is no move of the room unit. Thus, according to the aspect of the present disclosure, the transport unit and the room unit are separated after arriving at the designated place by the second user, so that the transport unit is not to be detained by the second user while the room unit is being used. Thereby, after transporting the room unit to the designated place by the second user, the transport unit can conduct other work, for example, so that it is possible to improve the operating rate of the transport unit.

Further, in an aspect of the present disclosure, the processor may be further configured to: when a use end notification of the room unit is received from the second user, determine a second transport unit that goes to the designated place by the second user to pick up the room unit; and cause the second transport unit to move to the designated place by the second user, connect to the room unit at the designated place by the second user, move to a predetermined place after connected to the room unit, and separate from the room unit at the predetermined place.

The second transport unit may be the transport unit that has transported the room unit to the designated place by the second user or may be a different transport unit. By determining the second transport unit for transporting the room unit and having it headed for the room unit after the use of the room unit by the second user is ended, the transport unit is to be used limitedly when the room unit needs to be moved. Thereby, the operating rate of the transport unit can be improved.

Further, in an aspect of the present disclosure, the processor may be further configured to: calculate a usage fee of the room unit of the second user; and allot, from the usage fee of the room unit, a pay for providing the room unit, a pay for transporting the room unit, and a pay for the first user for providing the first user's belonging. The pay may be a point, a coupon, cash, or the like, for example. Thereby, the pay for providing the first user's belonging is also payed to the first user who stores the first user's belonging in the room unit as the storeroom, so that it is possible to encourage the first user to provide the first user's belongings to the rental room.

Further, in an aspect of the present disclosure, the processor may be further configured to acquire a charged fee for the first user by subtracting the pay for providing the first user's belonging from the usage fee of the room unit as the storeroom charged to the first user. Thereby, the usage fee of the room unit as the storeroom charged to the first user can be reduced, so that it is possible to encourage the first user to use the room unit as the storeroom and to provide the first user's belongings.

Further, in an aspect of the present disclosure, the processor may be further configured to: when a storeroom use request is received from the first user, determine the room unit to be delivered to a designated place by the first user and a third transport unit that connects to the room unit and transports the room unit to the designated place by the first user; and cause the third transport unit connected to the room unit to move to the designated place by the first user. The third transport unit may be the transport unit that has transported the room unit to the designated place by the second user or may be different transport unit.

When the first user desires to store the first user's belonging in the storeroom, the room unit is transported to the designated place by the first user by the transport unit. Therefore, the first user does not need to bring the first user's belonging to the storeroom by the user oneself, so that the convenience when using the room unit as the storeroom can be improved. Thereby, it is also possible to encourage the first user to provide the first user's belongings to the rental room.

Further, in an aspect of the present disclosure, the processor may be further configured to cause the third transport unit to move to a predetermined place while being connected to the room unit, after the first user's belonging is housed in the room unit at the designated place by the first user. The predetermined place to which the third transport unit while being connected to the room unit moves may be a return place of the room unit, a standby place of the third transport unit, or the like, for example.

For example, in a case where the first user's belonging is housed inside the room unit immediately after the room unit arrives, the third transport unit may stand by at that place while being connected to the room unit. By moving the third transport unit to the predetermined place while being connected to the room unit after the first user's belonging is housed in the room unit, it is possible to house the first user's belonging inside the room unit while suppressing the operation of the third transport unit to the least.

Further, the processor may be further configured to cause the third transport unit to separate the room unit at the designated place by the first user. Furthermore, the processor may be further configured to: when a housing end notification of the first user's belonging is received from the first user, determine a fourth transport unit that goes to the designated place by the first user to pick up the room unit; and cause the fourth transport unit to move to the designated place by the first user, connect to the room unit at the designated place by the first user, and move to a predetermined place after being connected to the room unit.

For example, in a case where the first user's belonging to be stored in the room unit as the storeroom is large or heavy, it may take a long time to put the first user's belonging into the room unit. Further, there may be a case where it is not possible to put the first user's belonging into the room unit immediately after arrival of the room unit due to the circumstance of the first user. In such case, after delivering the room unit to the designated place by the first user, the third transport unit may separate the room unit and move to a predetermined place. Thereby, it is possible to conduct other work than transporting the room unit, or the like.

In the following, an embodiment of the present disclosure will be described with reference to the drawings. The configuration of the embodiment described below is an example, and the present disclosure is not limited to the configuration of the embodiment.

### First Embodiment

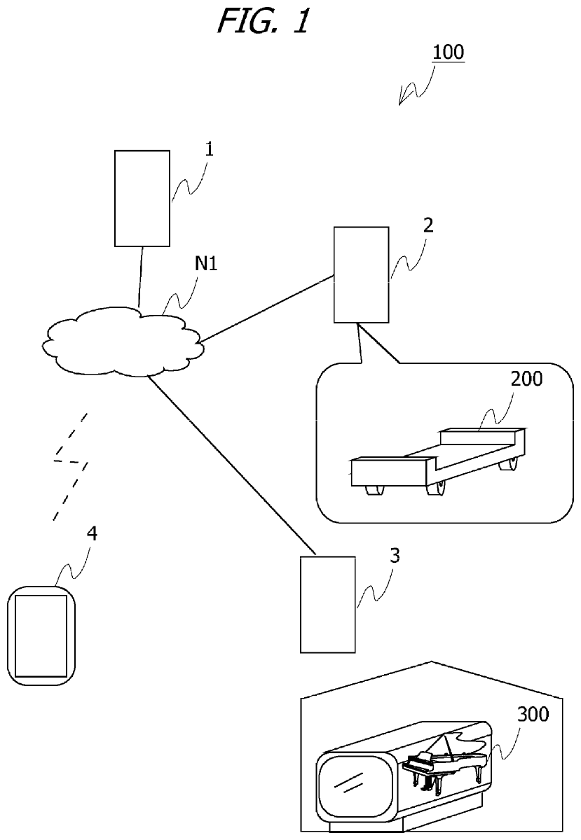

FIG. 1 is a diagram illustrating an example of a system configuration of a mobile rental-room providing system 100 according to a first embodiment. The mobile rental-room providing system 100 rents the room unit to the first user as a storeroom, for example, and houses, inside the room unit, the first user's belongings the first user does not use any more. Further, the mobile rental-room providing system 100 rents the room unit having the first user's belongings stored therein by the first user to the second user as a rental room. When the room unit is provided to the first user as the storeroom and when the room unit is provided to the second user as the rental room, the traveling unit and the room unit are connected to form a vehicle, and the room unit is transported to the second user. The first user is the user who uses the room unit as the storeroom. The second user is the user who uses the room unit as the rental room.

The mobile rental-room providing system 100 includes a center server 1, a vehicle management server 2 that manages a traveling unit 200, a storeroom management server 3 that manages a room unit 300 as a storeroom and a rental room, and a user terminal 4, for example. The user terminal 4 is a user terminal of the user who uses the room unit 300 as a storeroom or a rental room. In the user terminal 4, there is installed an application for using services provided by the mobile rental-room providing system 100, for example.

The center server 1, the vehicle management server 2, the storeroom management server 3, and the user terminal 4 are connected to a network N1 such as the Internet, for example. The center server 1, the vehicle management server 2, the storeroom management server 3, and the user terminal 4 are communicable via the network N1. Further, in the first embodiment, the traveling unit 200 has a communication function, and is capable of communicating with the vehicle management server 2 via the network N1. The room unit 300 may also have a communication function and communicate with the storeroom management server 3 via the network N1.

In the first embodiment, first, the center server 1 receives a use request for the storeroom or the rental room from the user terminal 4. The center server 1 acquires information regarding the available traveling unit 200 and room unit 300 from the vehicle management server 2 and the storeroom management server 3, respectively, and performs matching of the traveling unit 200 and the room unit 300. When matching is completed, the center server 1 moves the matched traveling unit 200 to the location of the matched room unit 300, and connects the traveling unit 200 and the room unit 300. The traveling unit 200 connected to the room unit 300 moves to the designated place by the user to provide the room unit 300 to the user as the storeroom or the rental room. After providing the room unit 300 to the user, the traveling unit 200 may separate the room unit 300 and move to the original standby place or to a place designated by an instruction received from the center server 1 or the vehicle management server 2.

In a case where the room unit 300 is used as the storeroom, a usage fee of the room unit 300 as the storeroom is charged to the user. Further, in a case where the room unit 300 is used as the rental room, a usage fee of the room unit 300 as the rental room is charged to the user. In both cases, according to the form of usage, a pay for the vehicle management server 2 for the transportation by the traveling unit 200 and a pay for the storeroom management server 3 for providing the room unit 300 are distributed in a predetermined proportion. In a case where the room unit 300 is used as the rental room, the pay is also distributed to the user who uses the room unit 300 as the storeroom and provides the his/her belongings.

For example, a piano is expensive and a larger space is needed for housing one. When the piano is not to be used any more, it is often selected to be left alone, sold, or kept in a storeroom. In the meantime, for those who is planning to learn to how to play the piano anew, it is not easy to purchase one because the price, the place to set, and the noise of the sound and the like at the time of practicing need to be considered.

According to the first embodiment, the user who does not use the piano any more can use the room unit 300 as the storeroom to keep the piano therein. Further, when providing the piano as a rental item, the user can also acquire a rental fee of the piano.

In the meantime, by renting the room unit 300 with the piano housed therein as a lesson room, the user who wants to learn the piano anew can use the piano at a low cost and secure the place for practice without worrying about where to set the piano.

Note that the equipment to be housed inside the room unit 300 is not limited to the piano. For example, the user's belongings housed in the room unit 300 also include large equipment such as a training machine, a massage chair, and a game machine, relatively small equipment such as a violin and audio equipment, and the like. Further, by housing a locker, a sofa, and the like in the room unit 300, for example, the room unit 300 can be provided as a mobile locker room.

### <Separable Vehicle>

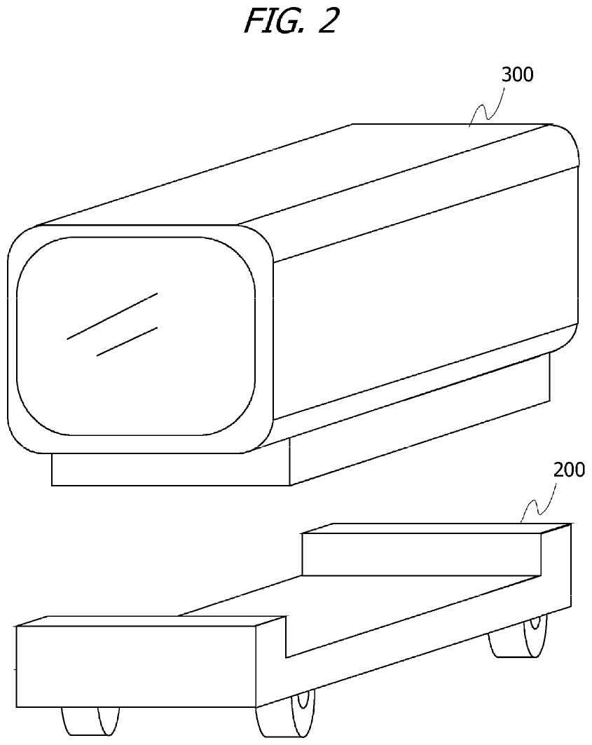

FIG. 2 is a diagram illustrating an example of a separable vehicle. In the first embodiment, it is assumed to use a separable vehicle with which the room unit and the traveling unit can be separated. As the separable vehicle, for example, there is a top-and-bottom separable vehicle in which the room unit 300 is loaded on the traveling unit 200 as illustrated in FIG. 2. However, the separable vehicle is not limited to the top-and-bottom separable vehicle. For example, there may also be a front-and-rear separable vehicle in which a traveling unit is connected to the front of a room unit and travels by towing the room unit. The traveling unit 200 and the room unit 300 are connected by a predetermined method. The connecting method of the traveling unit 200 and the room unit 300 is not limited to a specific method but any of existing techniques may be used. For example, as the connecting method of the traveling unit 200 and the room unit 300, there are a method using a connecting/separating mechanism, a method using an electromagnet, and the like. Further, as a method for loading the room unit 300 onto or down from the traveling unit 200 with the top-and-bottom separable vehicle, for example, there are a method using a dedicated lift, a method using a mechanism for loading on or down provided to the room unit 300 or the traveling unit 200 itself, and the like. The method for loading the room unit 300 onto or down from the traveling unit 200 with the top-and-bottom separable vehicle is not limited to a specific method.

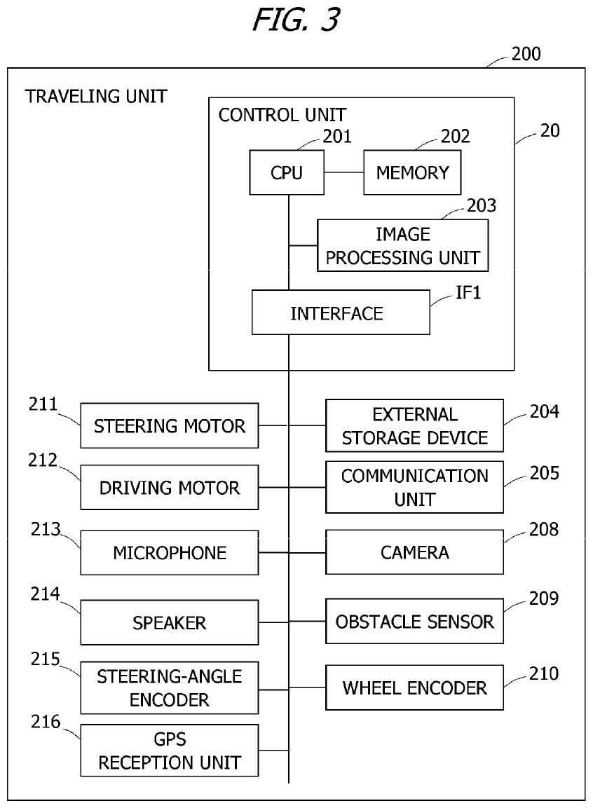

FIG. 3 is a diagram illustrating an example of a hardware configuration of the traveling unit 200. In the first embodiment, the traveling unit 200 is assumed as an autonomous electrically driven vehicle. Therefore, FIG. 3 illustrates a case where it is assumed that the traveling unit 200 is an autonomous electrically driven vehicle. Note that hardware related to a control system of the traveling unit 200 is extracted and illustrated in FIG. 3.

The traveling unit 200 includes a control unit 20, an external storage device 204, a communication unit 205, a camera 208, an obstacle sensor 209, a wheel encoder 210, a steering motor 211, a driving motor 212, a microphone 213, a speaker 214, a steering-angle encoder 215, and a GPS (Global Positioning System) reception unit 216.

The control unit 20 is also referred to as an electronic control unit (ECU). The control unit 20 includes a CPU 201, a memory 202, an image processing unit 203, and an interface IF1. To the interface IF1, the external storage device 204, the communication unit 205, the camera 208, the obstacle sensor 209, the wheel encoder 210, the steering motor 211, the driving motor 212, the microphone 213, the speaker 214, the steering-angle encoder 215, and the GPS reception unit 216 are connected.

The obstacle sensor 209 is an ultrasonic sensor, a radar, or the like. The obstacle sensor 209 emits an ultrasonic wave, an electromagnetic wave, or the like toward a detection-target direction, and detects presence, position, relative speed, and the like of an obstacle in the detection-target direction based on a reflected wave. Examples of the obstacle may be a pedestrian, a bicycle, a structure, and a building. For example, in a case where the traveling unit 200 is in a box shape as illustrated in FIG. 2, a plurality of obstacle sensors 209 are provided, and each of the plurality of obstacle sensors 209 is provided at a position close to four corner areas in the front, rear, left, and right of the traveling unit 200. Note that the front, rear, left, and right of the traveling unit 200 are determined according to the traveling direction, for example.

The camera 208 is an imaging device using an image sensor such as a charged-coupled device (CCD), a metal-oxide-semiconductor (MOS), a complementary-metal-oxide-semiconductor (CMOS) or the like. The camera 208 acquires an image at a predetermined time interval called a frame period, and stores the acquired images in a frame buffer within the control unit 20. A plurality of cameras 208 are provided to the traveling unit 200, and the plurality of cameras 208 are set toward the outer side of the vehicle at each of side faces in the front, rear, left, and right of the traveling unit 200, for example.

The steering motor 211, according to a direction signal from the control unit 20, controls the direction of an intersection line along which the wheel rotation plane intersects with the horizontal plane, that is, the angle to be the traveling direction by rotation of the wheels. The driving motor 212, according to a direction signal from the control unit 20, drives and rotates each of the wheels provided to the traveling unit 200, for example. Note, however, that the driving motor 212 may drive either one out of two pairs of wheels in the front and rear.

The steering-angle encoder 215 detects the steering angle as the traveling direction of the wheels at a predetermined detection time interval, and stores the detected steering angles in a register of the control unit 20. The steering angle is the angle of the rotation axis of the wheels within the horizontal plane. For example, the origin of the angles is set in the direction along which the rotation axis of the wheels is orthogonal to the traveling direction of the traveling unit 200. Further, the wheel encoder 210 acquires the rotation angle of the wheels at a predetermined detection time interval, and stores the acquired rotation angles in a register of the control unit 20.

The communication unit 205 is a communication unit that is connected to a WiFi access point or a mobile-phone base station, for example, and communicates with various kinds of servers and the like on the network via a public communication network connected thereto. The communication unit 205 performs wireless communication with wireless signals and a wireless communication method conforming to a predetermined wireless communication standard.

The GPS reception unit 216 receives radio waves of time signals from a plurality of artificial satellites (Global Positioning Satellites) orbiting the earth, and stores the received time signals in a register of the control unit 20. The microphone 213 detects voices, converts the voices to digital signals, and stores the digital signals to a register of the control unit 20. The speaker 214 is driven by a D/A converter and an amplifier connected to the control unit 20 or a signal processing unit, and reproduces acoustics including sounds and voices.

The CPU 201 of the control unit 20 executes a computer program expanded on the memory 202 to be executable so as to execute processing as the control unit 20. In the memory 202, the computer program executed by the CPU 201, data, and the like to be processed by the CPU 201 are stored. The memory 202 may be a dynamic random access memory (DRAM), a static random access memory (SRAM), a read only memory (ROM), or the like, for example. The image processing unit 203 cooperates with the CPU 201 to process the data in the frame buffer acquired from the camera 208 by every predetermined frame period. The image processing unit 203 includes a GPU and an image memory to be the frame buffer, for example. The external storage device 204 is a nonvolatile storage device, and examples thereof may be a solid state drive (SSD), a hard disk drive, and the like.

For example, the control unit 20 acquires detection signals from sensors of each unit of the traveling unit 200 via the interface IF1. Further, the control unit 20 calculates the latitude and the longitude as the position on the earth based on the detection signals from the GPS reception unit 216. Further, the control unit 20 acquires map data from a map information database stored in the external storage device 204, and collates the calculated latitude and longitude with the position on the map data to determine the current position. Further, the control unit 20 acquires a route from the current position to a destination on the map data. Furthermore, the control unit 20 detects obstacles in the surroundings of the traveling unit 200 based on the signals from the obstacle sensor 209, the camera 208, and the like, determines the traveling direction by avoiding the obstacles, and control the steering angle.

Further, the control unit 20 cooperates with the image processing unit 203 to process the images acquired from the camera 208 by each frame data, and detects a change based on a difference between the images, for example, to recognize an obstacle. Note that the control unit 20 may transmit the frame data of the images from the camera 208 and voice data acquired from the microphone 213 to the center server 1 on the network from the communication unit 205. Then, the frame data of the images and the voice data may be analyzed by the center server 1.

While the interface IF1 is illustrated as an example in FIG. 3, exchange of the signals between the control unit 20 and a control subject is not limited to be done via the interface IF1. That is, the control unit 20 may have a plurality of signal exchanging paths other than the interface IF1. Further, in FIG. 3, the control unit 20 includes the single CPU 201. However, the CPU is not limited to a single processor but may be of a multiprocessor configuration. Further, a single CPU connected via a single socket may have a multicore configuration. At least part of processing of each of the above-described units may be executed by a processor other than the CPU, such as a dedicated processor that may be a digital signal processor (DSP), a graphics processing unit (GPU), or the like, for example. Further, at least part of the processing of each of the above-described units may be an integrated circuit or a digital circuit other than that. Further, an analog circuit may be included at least in part of each of the above-described units.

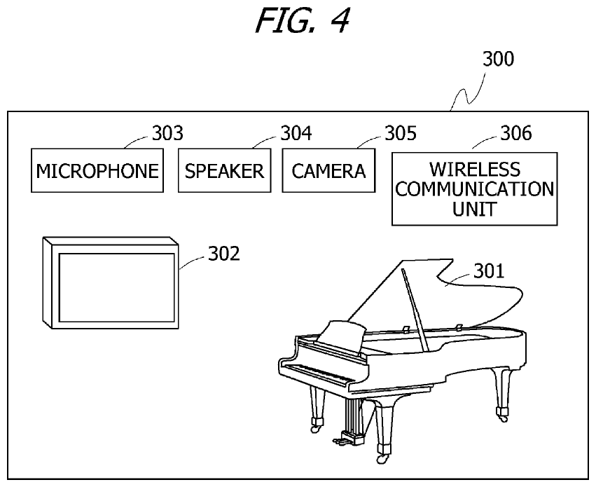

FIG. 4 is a diagram illustrating an example of specifications of the room unit 300. FIG. 4 is an example of a case where the room unit 300 is rented as a lesson room for the piano. Inside the room unit 300, a piano 301, a display 302, a microphone 303, a speaker 304, a camera 305, and a wireless communication unit 306 are provided. The piano 301 is the piano owned by the first user and kept in the room unit 300 as the storeroom. The display 302 may be owned by the first user who is using the room unit 300 as the storeroom, may be owned by other users, or may be prepared by the manager of the storeroom management server 3.

For example, the wireless communication unit 306 is a communication unit that is connected to a WiFi access point or a mobile-phone base station, for example, and communicates with other terminals on the network via a public communication network connected thereto.

For example, the user who uses the room unit 300 as the lesson room for the piano can have a lesson while communicating with a teacher at a distant location via communication using the wireless communication unit 306. Specifically, images or videos and sounds acquired inside the room unit 300 acquired by the camera 305 and the microphone 303 are transmitted to the terminal of the teacher side via the wireless communication unit 306. In the meantime, images or videos and sounds received from the terminal of the teacher side are outputted from the display 302 and the speaker 304. This makes it possible to achieve a remote lesson.

Note that the inside specifications of the room unit 300 in FIG. 4 illustrate an example, and it is not intended to be limited thereto. The inside specifications of the room unit 300 are to change depending on the usage when the room unit 300 is rented as a rental room.

### <Apparatus Configuration>

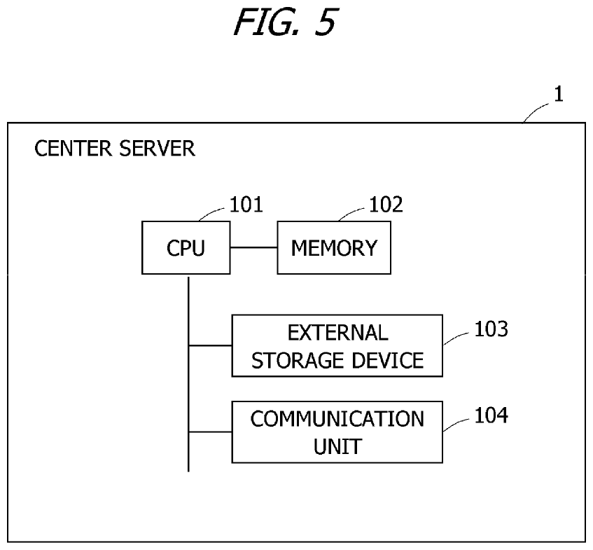

FIG. 5 is a diagram illustrating an example of a hardware configuration of the center server 1 according to the first embodiment. The center server 1 is a dedicated computer or a multi-purpose computer, for example. The center server 1 includes, as the hardware configuration, a CPU (Central Processing Unit) 101, a memory 102, an external storage device 103, and a communication unit 104. The memory 102 and the external storage device 103 are recording media that can be read by the computer. The center server 1 is an example of the “information processing apparatus”.

The external storage device 103 stores various programs and data used by the CPU 101 when executing each of the programs. The external storage device 103 is an EPROM (Erasable Programmable ROM) or a hard disk drive, for example. Examples of the programs held in the external storage device 103 may be an operating system (OS), a control program of the mobile rental-room providing system 100, and various other application programs. The control program of the mobile rental-room providing system 100 is a program for matching the room unit 300 to be provided to the user and the traveling unit 200 for transporting the room unit 300, and for delivering the room unit 300 to a designated place by the user.

The memory 102 is a main memory that provides a storage area and a work area for the CPU 101 to load the programs stored in the external storage device 103, and is used as a buffer. The memory 102 includes a semiconductor memory such as a ROM (Read Only Memory) or a RAM (Random Access Memory), for example.

The CPU 101 has the OS and various application programs held in the external storage device 103 loaded on the memory 102, and executes those to execute various kinds of processing. The CPU 101 is not limited to be one, but a plurality of those may be provided. The CPU 101 is an example of the “processor” of the “information processing apparatus”.

The communication unit 104 is an interface for inputting and outputting information with the network. The communication unit 104 may be an interface connected to a wired network or may be an interface connected to a wireless network. The communication unit 104 is an NIC (Network Interface Card), a wireless circuit, or the like, for example. The communication unit 104 is connected to a LAN (Local Network Area), for example, connected to a public communication network via the LAN, and communicates with various kinds of servers and the user terminal 4 on the network via the public communication network.

Note that the hardware configuration of the center server 1 illustrated in FIG. 5 is an example, and it is not intended to be limited thereto. It is possible to omit, replace, or add structural elements as appropriate according to embodiments. For example, the center server 1 may include a removable recording medium drive, and execute programs recorded in removable recording media. The removable recording medium is a recording medium such as an SD card, mini SD card, a micro SD card, a USB (Universal Serial Bus), a flash memory, a CD (Compact Disk), a DVD (Digital Versatile Disc), a Blu-ray® Disc, or a flash memory card. Further, for example, the center server 1 may include an input apparatus and an output apparatus. The input apparatus is a keyboard, a mouse, a touch panel, or the like, for example. The output apparatus is a display or the like, for example.

Like the center server 1, the vehicle management server 2 and the storeroom management server 3 are also dedicated or multi-purpose computers, and the hardware configurations thereof are also the same as that of the center server 1. Therefore, illustrations and explanations thereof are omitted. Examples of the user terminal 4 may be a smartphone, a tablet terminal, a PC (Personal Computer), a wearable terminal, and the like. The user terminal 4 includes, as the hardware configuration, a touch panel display, a speaker, a microphone, a camera, a GPS reception unit, various kinds of sensors, and the like in addition to a CPU, a memory, an external storage device, and a communication unit.

Note that a series of processing executed by the center server 1, the vehicle management server 2, the storeroom management server 3, and the user terminal 4 is not limited to be achieved by execution of software by the processor. Such processing can be achieved by hardware such as an FPGA (Field-Programmable Gate Array) or the like, for example.

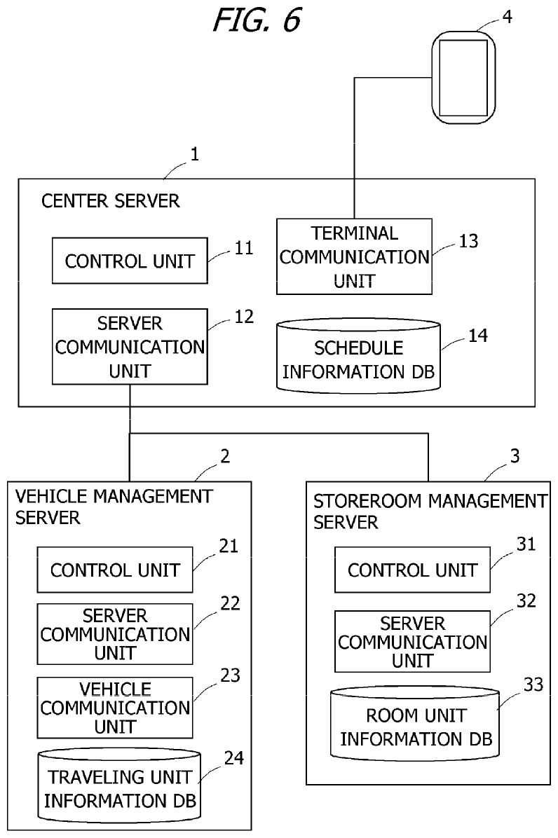

FIG. 6 is a diagram illustrating an example of a functional configuration of the center server 1, the vehicle management server 2, and the storeroom management server 3 in the mobile rental-room providing system 100. The center server 1 includes a control unit 11, a server communication unit 12, a terminal communication unit 13, and a schedule information database (DB) 14 as functional structural elements. For example, those functional structural elements are achieved by executing, by the CPU 101 of the center server 1, the control program of the mobile rental-room providing system 100 stored in the external storage device 103.

The server communication unit 12 is an interface for communicating with the vehicle management server 2 and the storeroom management server 3. The server communication unit 12 transmits data inputted from the control unit 11 to the vehicle management server 2 or the storeroom management server 3 via the communication unit 104, for example. Further, the server communication unit 12 receives data from the vehicle management server 2 or the storeroom management server 3 via the communication unit 104, and outputs the received data to the control unit 11.

The terminal communication unit 13 is an interface for communicating with the user terminal 4. The communication terminal unit 13 transmits the data inputted from the control unit 11 to the user terminal 4 via the communication unit 104, for example. Further, the terminal communication unit 13 receives the data from the user terminal 4 via the communication unit 104, and outputs the received data to the control unit 11. For example, as the data received from the user terminal 4, there is a storeroom use request and a rental room use request. Along with the storeroom use request, for example, information regarding the user, information regarding the user's belonging to be kept in the storeroom, information regarding the designated place for delivering the room unit 300, information regarding planned start and end date/time for putting the user's belonging in, and the like are also received. Along with the rental room use request, for example, information regarding the user, information regarding the room unit 300 to be rented, information regarding the designated place for delivering the room unit 300, information regarding planned start and end date/time for rental, and the like are also received. The information regarding the user includes identification information of the user, for example.

The control unit 11 receives, from the terminal communication unit 13, for example, input of a storeroom or rental room use request received from the user terminal 4. In this case, the control unit 11 acquires information regarding the available traveling unit 200 and information regarding the room unit 300 from the vehicle management server 2 and the storeroom management server 3, respectively. For example, the available traveling unit 200 is the traveling unit 200 that has no schedule at least on the planned start date/time for putting the user's belonging in or the planned start date/time for rental, and is also capable of transporting the room unit 300 that can house the user's belonging to be kept in the storeroom or capable of transporting the room unit 300 that matches a desired condition of the user for the rental room. For example, the available room unit 300 is the room unit 300 that has no schedule at least from the planned start date/time to the planned end date/time for putting the user's belonging in or from the planned start date/time to the planned end date/time for rental, and also can house the user's belonging to be kept in the storeroom or matches the desired condition of the user for the rental room. The desired condition of the user for the rental room includes types and specifications of rental rooms, things provided therein, and the like, for example, and it is included in the information regarding the room unit 300 to be rented.

The information regarding the traveling unit 200 includes, for example, identification information of the traveling unit 200, loadable weight and size of the traveling unit 200, information regarding the set schedule, positional information, and the like. The information regarding the room unit 300 includes, for example, identification information of the room unit 300, information regarding the size, weight, specifications, and housed articles, and the like.

Specifically, upon receiving a storeroom use request, the control unit 11 transmits, to the vehicle management server 2 and the storeroom management server 3 via the server communication unit 12, an information acquisition request, the information regarding the user's belonging to be kept in the storeroom, the information regarding the designated place for delivering the room unit 300, and the information regarding planned start and end date/time for putting the user's belonging in. Further, upon receiving a rental room use request, the control unit 11 transmits, to the vehicle management server 2 and the storeroom management server 3 via the server communication unit 12, an information acquisition request, the information regarding the room unit 300 to be rented, the information regarding the designated place for delivering the room unit 300, and the information regarding planned start and end date/time for rental.

Upon acquiring the information regarding the available traveling unit 200 and the information regarding the room unit 300 from the vehicle management server 2 and the storeroom management server 3, respectively, the control unit 11 performs matching of the room unit 300 to be provided and the traveling unit 200 for delivering the room unit 300.

Then, the control unit 11 generates schedule information such that the matched traveling unit 200 and room unit 300 arrive at the designated place by the user on the designated date/time by the user. The designated date/time by the user is the planned start date/time for putting the user's belonging in the storeroom or the planned start date/time for renting the rental room, for example. The schedule information includes, for example, operation start date/time of the traveling unit 200 when departing for the room unit 300, the information regarding the location of the room unit 300, the information regarding the designated place by the user, and the information regarding the designated date/time by the user. The operation start date/time of the traveling unit 200 may be set before a predetermined time from the designated date/time by the user or may be determined based on the positional relation of the traveling unit 200, the room unit 300, and the designated place by the user, for example. The information regarding the designated date/time by the user is the information regarding the planned start and end date/time for putting the user's belonging in or regarding the planned start and end date/time for rental.

The control unit 11 transmits the generated information to the vehicle management server 2 and the storeroom management server 3 via the server communication unit 12. Further, via the terminal communication unit 13, the control unit 11 transmits, at least, the information of the matched traveling unit 200 and room unit 300 to the user terminal 4 as a response for the use request.

Thereafter, at the start time of the schedule, that is, at the operation start date/time of the traveling unit 200 departing for the location of the room unit 300, the control unit 11 transmits a delivery start instruction to the vehicle management server 2 to give an instruction to start the operation of the traveling unit 200. Along with the delivery start instruction, operation plan information for the traveling unit 200 is also transmitted. The operation plan information is generated by the control unit 11. The operation plan information includes instructions to, for example, move to the location of the room unit 300, connect to the room unit 300 at the location of the room unit 300, move to the designated place by the user, and separate the room unit 300 at the delivery designated place by the user in this order.

Then, the control unit 11 receives, via the terminal communication unit 13, input of a use end notification of the storeroom or the rental room received from the user terminal 4. When the use end notification of the storeroom or the rental room is received from the user terminal 4 or when it reaches the planned end date/time for putting the user's belonging in or the planned end date/time for rental, the control unit 11 acquires the information regarding the available traveling unit 200 from the vehicle management server 2. Then, based on the acquired information, the control unit 11 determines the traveling unit 200 for picking up the room unit 300.

Upon determining the traveling unit 200 for picking up the room unit 300, the control unit 11 transmits a pickup instruction to the vehicle management server 2. Along with the pickup instruction, information regarding the traveling unit 200 used for pickup and the operation plan information for the traveling unit 200 are also transmitted. This operation plan information is also generated by the control unit 11. The operation plan information includes instructions to, for example, move to the designated place by the user at which the room unit 300 is set, connect to the room unit 300 at the designated place by the user, move to a return place of the room unit 300, and separate the room unit 300 at the return place of the room unit 300 in this order. The return place of the room unit 300 may be determined in advance or may be included in the information regarding the room unit 300 received from the storeroom management server 3, for example.

For example, when the room unit 300 arrives at the return place, a pickup completion notification is transmitted to the center server 1 from the storeroom management server 3. Further, for example, when the traveling unit 200 that has picked up the room unit 300 returns to a standby place, a pickup completion notification is transmitted to the center server 1 from the vehicle management server 2. For example, upon receiving the pickup completion notifications from both the vehicle management server 2 and the storeroom management server 3, the center server 1 calculates a usage fee of the storeroom or the rental room. The usage fee of the storeroom or the rental room is calculated based on respective charge lists, for example. Note that calculation of the usage fee of the storeroom or the rental room by the center server 1 is not limited to be executed when the pickup completion notifications are received from both the vehicle management server 2 and the storeroom management server 3 but may also be executed when the pickup completion notification is received from the storeroom management server 3, for example. Further, since the room unit 300 is used for a long period of time such as for several months to several years when used as the storeroom, the usage fee of the first month or the first year may be calculated, for example.

Further, the control unit 11 allots the pay for the transportation by the traveling unit 200 and for providing the room unit 300 from the usage fee of the storeroom or the rental room. Further, when the room unit 300 is used as the rental room, the control unit 11 allots the pay for providing the user's belonging housed in the room unit 300 from the usage fee of the rental room. The pay for transportation by the traveling unit 200 is payed to the manager of the vehicle management server 2. The pay for providing the room unit 300 is payed to the manager of the storeroom management server 3. The pay for providing the user's belonging housed in the room unit 300 is payed to the user who is the owner of the belonging and using the room unit 300 as the storeroom.

The schedule information DB 14 is generated in a storage area of the external storage device 103, for example. In the schedule information DB 14, use schedule information of the room unit 300 is stored. Details of the information stored in the schedule information DB 14 will be described later. The schedule information DB 14 is managed by the control unit 11.

Next, the vehicle management server 2 includes, as functional structural elements, a control unit 21, a server communication unit 22, a vehicle communication unit 23, and a traveling unit information DB 24. Those functional structural elements are achieved by executing, by the CPU of the vehicle management server 2, the control program for the vehicle management server 2 of the mobile rental-room providing system 100 stored in the external storage device, for example.

The server communication unit 22 is an interface for communicating with the center server 1. The server communication unit 22 transmits data inputted from the control unit 21 to the center server 1, for example. Further, the server communication unit 22 receives data from the center server 1, and outputs the received data to the control unit 21.

The vehicle communication unit 23 is an interface for communicating with the traveling unit 200. The vehicle communication unit 23 transmits data inputted from the control unit 21 to the traveling unit 200, for example. Further, the vehicle communication unit 23 receives data from the traveling unit 200, and outputs the received data to the control unit 21. Examples of the data exchanged between the traveling unit 200 and the vehicle management server 2 may be a traveling instruction, positional information of the traveling unit 200, and the like.

The control unit 21 receives input of an information acquisition request received from the center server 1 via the server communication unit 22. Along with the information acquisition request, the information regarding the user's belonging to be kept in the storeroom, the information regarding the designated place for delivering the room unit 300, and the information regarding the planned start and end date/time for putting the user's belonging in are received (in a case of occurrence of a storeroom use request). Alternatively, along with the information acquisition request, the information regarding the room unit 300 to be rented, the information regarding the designated place for delivering the room unit 300, and the information regarding the planned start and end date/time for rental are received (in a case of occurrence of a rental room use request).

When the information acquisition request is received from the center server 1, the control unit 21 acquires the information regarding the available traveling unit 200 from the traveling unit information DB 24. The available traveling unit 200 is the traveling unit 200 that has no schedule set at least on the planned start data/time or planned end date/time for putting the user's belonging in or for rental or at the current time, and is also capable of transporting the room unit 300 that can house the user's belonging to be kept therein as the storeroom or the room unit 300 that satisfies the desired condition of the user for the rental room. The control unit 21 transmits the acquired information regarding the traveling unit 200 to the center server 1 via the server communication unit 22.

When a delivery start instruction or a pickup instruction is received from the center server 1, the control unit 21 controls travel of the corresponding traveling unit 200 according to the operation plan information received along with the delivery start instruction or the pickup instruction. The method for controlling travel of the traveling unit 200 by the vehicle management server 2 may be any of existing methods.

Further, the control unit 21 acquires the positional information from the traveling unit 200 in a predetermined period. For example, based on the positional information of the traveling unit 200, a user operation inputted from the input apparatus of the traveling unit 200, or the like, it is detected that the traveling unit 200 has completed the delivery of the room unit 300 to the designated place of the user or has completed the pickup of the room unit 300. In this case, the control unit 21 transmits a delivery completion or pickup completion notification to the center server 1 via the server communication unit 22.

The traveling unit information DB 24 is generated in the storage area of the external storage device of the vehicle management server 2. The traveling unit information DB 24 stores the information regarding the traveling unit 200. Details of the information stored in the traveling unit information DB 24 will be described later. The traveling unit information DB 24 is managed by the control unit 21.

Next, the storeroom management server 3 includes, as the functional structural elements, a control unit 31, a server communication unit 32, and a room unit information DB 33. Those functional structural elements are achieved by executing, by the CPU of the storeroom management server 3, the control program for the storeroom management server 3 of the mobile rental-room providing system 100 stored in the external storage device, for example.

The server communication unit 32 is an interface for communicating with the center server 1. The server communication unit 32 transmits data inputted from the control unit 31 to the center server 1, for example. Further, the server communication unit 32 receives data from the center server 1, and outputs the received data to the control unit 31.

The control unit 31 receives input of an information acquisition request received from the center server 1 via the server communication unit 32. Along with the information acquisition request, the information regarding the user's belonging to be kept in the storeroom, the information regarding the designated place for delivering the room unit 300, and the information regarding the planned start and end date/time for putting the user's belonging in are received. Alternatively, along with the information acquisition request, the information regarding the room unit 300 to be rented, the information regarding the designated place for delivering the room unit 300, and the information regarding the planned start and end date/time for rental are received.

When the information acquisition request is received from the center server 1, the control unit 31 acquires, from the room unit information DB 33, the information regarding the room unit 300 that has no schedule set at least from the planned start data/time to the planned end date/time for putting the user's belonging in or for rental, and is capable of housing the user's belonging to be kept in the storeroom or matches the desired condition of the user for the rental room. The control unit 31 transmits the acquired information regarding the room unit 300 to the center server 1 via the server communication unit 32.

Further, based on the positional information of the room unit 300, a user operation inputted from the input apparatus provided to the room unit 300, detection values of a sensor provided at the return place of the room unit 300, and the like, for example, the control unit 31 detects that the room unit 300 has arrived at the designated place by the user or that the room unit 300 has returned to the return place. In this case, the control unit 31 transmits a delivery completion or pickup completion notification to the center server 1 via the server communication unit 32.

The room unit information DB 33 is generated in the storage area of the external storage device of the storeroom server 3. The room unit information DB 33 stores the information regarding the room unit 300. Details of the information stored in the room unit information DB 33 will be described later. The room unit information DB 33 is managed by the control unit 31.

Note that each of the functional structural elements of the center server 1, the vehicle management server 2, and the storeroom management server 3 may be achieved by processing executed by different apparatuses or may be achieved by processing executed by a single apparatus. For example, each of the schedule information DB 14, the traveling unit information DB 24, and the room unit information DB 33 may be held by an external server. Further, for example, the functional configuration of a combination of the two out of the center server 1, the vehicle management server 2, and the storeroom management server 3 may be achieved by the processing executed by a single apparatus.

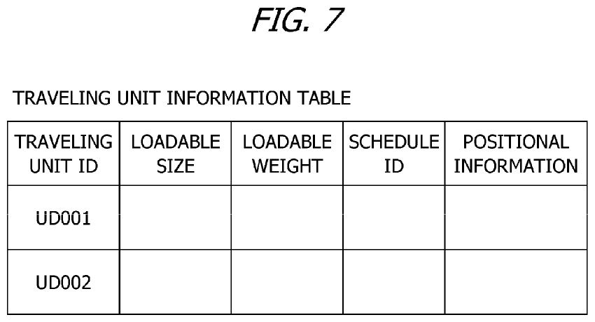

FIG. 7 is an example of a traveling unit information table. The traveling unit information table is a table held in the traveling unit information DB 24 of the vehicle management server 2. The information regarding the traveling unit 200 is stored in the traveling unit information table. The traveling unit information table illustrated in FIG. 7 includes fields of traveling unit ID, loadable size, loadable weight, schedule ID, and positional information.

In the field of the traveling unit ID, identification information of the traveling unit 200 is stored. In the field of the loadable size, the largest loadable size of the traveling unit 200 is stored. In the field of the loadable weight, the heaviest loadable weight of the traveling unit 200 is stored. In the field of the schedule ID, identification information of the schedule allotted to the traveling unit 200 is stored. The schedule ID is defined to be a common value for the center server 1, the vehicle management server 2, and the storeroom management server 3. In the field of the positional information, the positional information of the traveling unit 200 received from the traveling unit 200 in a predetermined period is stored.

The values in the fields of the traveling unit ID, the loadable size, and the loadable weight are inputted in advance by the manager of the vehicle management server 2. The value in the field of the schedule ID is updated by the control unit 21 when the schedule is set for the traveling unit 200, for example. The value in the field of the positional information is updated by the control unit 21 every time the positional information is received from the traveling unit 200, for example.

The information transmitted to the center server 1 from the vehicle management server 2 when the information acquisition request is received from the center server 1, for example, may be the whole entries of the traveling unit information table of the corresponding traveling unit 200 or may be the values in the fields of the traveling unit ID, the loadable size, and the loadable weight. Note that the information stored in the traveling unit information table is not limited to those illustrated in FIG. 7.

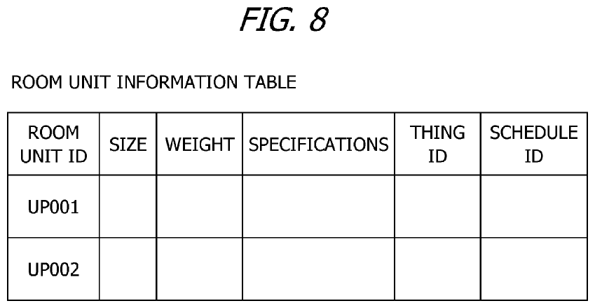

FIG. 8 is an example of a room unit information table. The room unit information table is a table held in the room unit information DB 33 of the storeroom management server 3. The information regarding the room unit 300 is stored in the room unit information table. The room unit information table illustrated in FIG. 8 includes fields of room unit ID, size, weight, specifications, thing ID, and schedule ID.

In the field of the room unit ID, identification information of the room unit 300 is stored. In the field of the size, the size of the corresponding room unit 300 is stored. In the field of the weight, the weight of the corresponding room unit 300 is stored.

In the field of the specifications, information indicating the specifications of the corresponding room unit 300 is stored. For example, as the specifications of the room unit 300, there may be a music lesson room, a karaoke room, a game room, a training room, and the like. The information indicating the specifications of the room unit 300 is a code, a flag, or the like indicating one of those specifications, for example.

In the field of the thing ID, identification information of the user's belonging housed in the corresponding room unit 300 is stored. For example, the corresponding belonging may be the user's belonging kept by the user who uses the room unit 300 as the storeroom or the thing owned by the manager of the storeroom management server 3. The information regarding the thing is held in a thing information table stored in the room unit information DB 33. The thing information table includes the identification information of the things, types of the things, information indicating the owners of the things, and the like, for example.

In the field of the schedule ID, identification information of the schedule allotted to the room unit 300 is stored. The schedule ID is defined to be a common value for the center server 1, the vehicle management server 2, and the storeroom management server 3.

The values in the fields of the room unit ID, the size, the weight, and the specifications are inputted in advance by the manager of the storeroom management server 3. The field of the thing ID is updated by the control unit 31, when there is update regarding the equipment housed in the corresponding room unit 300. The value in the field of the schedule ID is updated by the control unit 31, when the schedule is set for the corresponding room unit 300, for example.

The information transmitted to the center server 1 from the storeroom management server 3 when the information acquisition request is received from the center server 1, for example, may be the whole entries of the room unit information table of the corresponding room unit 300 or may be the values in the fields of the room unit ID, the size, and the weight, the specifications, and thing ID. Note that the information stored in the room unit information table is not limited to those illustrated in FIG. 8.

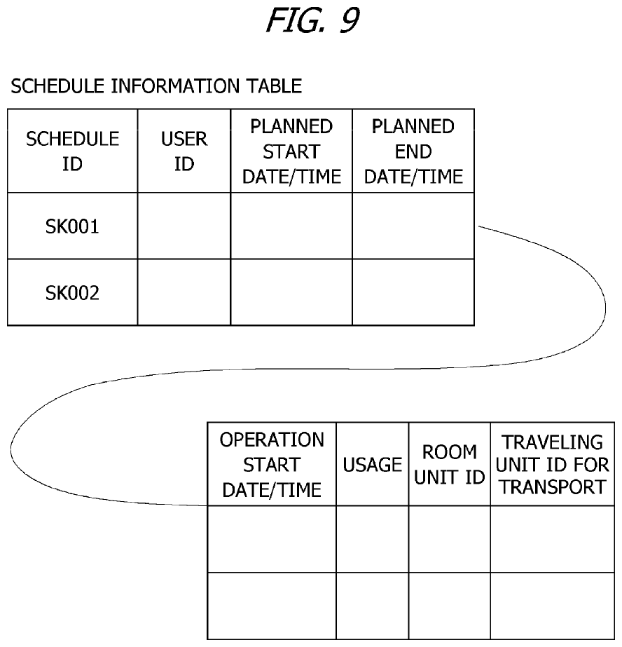

FIG. 9 is an example of a schedule information table. The schedule information table is a table held in the schedule information DB 14 of the center server 1. Information regarding the use schedule of the room unit 300 is held in the schedule information table. The schedule information table illustrated in FIG. 9 includes fields of schedule ID, user ID, planned start date/time, planned end date/time, operation start date/time, usage, room unit ID, and traveling unit ID for transport.

In the field of the schedule ID, identification information of the schedule information is stored. In the field of the user ID, identification information of the user as the subject of the corresponding schedule is stored. In the field of the planned start date/time, the planned start date/time for putting the user's belonging in or for rental designated by the user is stored. In the field of the planned end date/time, the planned end date/time for putting the user's belonging in or for rental designated by the user is stored.

In the field of the operation start date/time, the operation start date/time of the traveling unit 200 allotted on the corresponding schedule is stored. In the field of the usage, stored is information indicating whether the usage of the room unit 300 in the corresponding schedule is “storeroom” or “rental”. The information indicating the usage stored in the field of the usage is a code, a flag, or the like, for example.

In the field of the room unit ID, identification information of the room unit 300 to be provided on the corresponding schedule is stored. In the field of the traveling unit ID for transport, stored is identification information of the traveling unit 200 allotted on the corresponding schedule to transport the room unit 300.

The schedule information is generated by the control unit 11 of the center server 1, when matching of the traveling unit 200 and the room unit 300 is performed in response to a storeroom or rental room use request transmitted from the user terminal 4, for example. When the schedule information is generated, each field of the entries of the schedule information table is also generated. The values in the fields of the user ID, the planned start date/time, the planned end date/time, and the usage are acquired from the information that is received along with the storeroom or rental room use request transmitted from the user terminal 4. The values in the fields of the room unit ID, the traveling unit ID for transport, and the operation start date/time are acquired when, for example, the room unit 300 to which the corresponding schedule is allotted is matched with the traveling unit 200 by the control unit 11.

The schedule information is transmitted from the center server 1 to the vehicle management server 2 and also to the storeroom management server 3. Therefore, the vehicle management server 2 and the storeroom management server 3 also have the schedule information table like the center server 1 does. For example, the vehicle management server 2 has the schedule information table in the traveling unit information DB 24. The storeroom management server 3 has the schedule information table in the room unit information DB 33. Note that the schedule information illustrated in FIG. 9 is an example, and the information stored in the schedule information table is not limited to those illustrated in FIG. 9.

### <Flow of Processing>

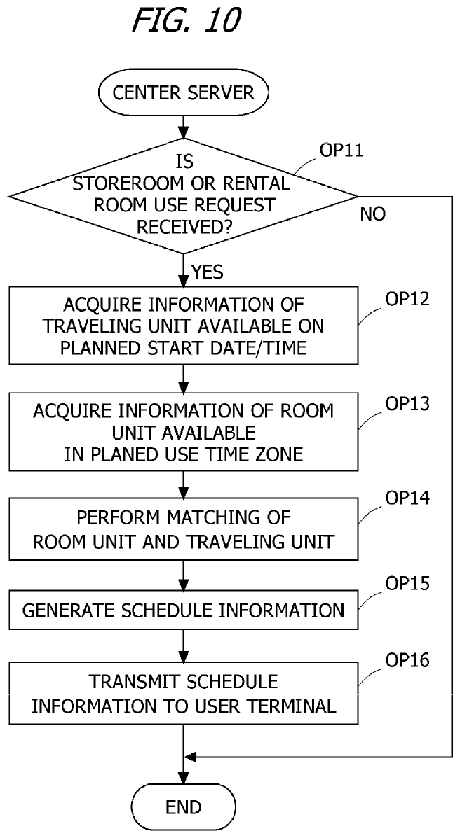

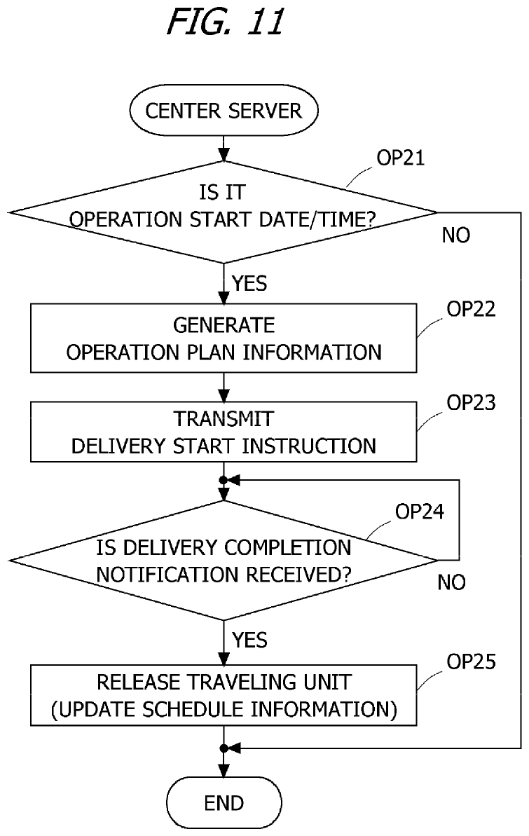

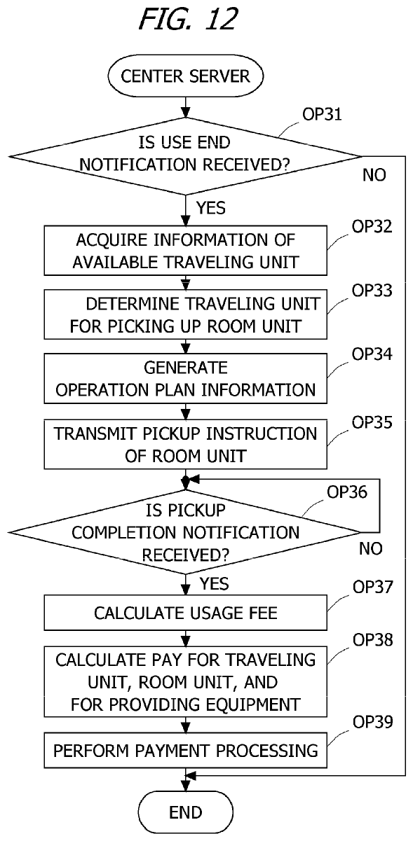

FIG. 10 is an example of a flowchart of the processing of the center server 1, when a use request for the room unit 300 is received. The processing illustrated in FIG. 10 is repeatedly executed in a predetermined period, for example. While the execution subject of the processing illustrated in FIG. 10 is the CPU 101 of the center server 1, the control unit 11 as the functional structural element is described as the main subject for convenience. It is also the same in the following flowcharts of FIG. 11 and FIG. 12.

In OP11, the control unit 11 determines whether or not a storeroom or rental room use request is received from the user terminal 4. When the storeroom or rental room use request is received from the user terminal 4 (OP11: YES), the processing is shifted to OP12. When no storeroom or rental room use request is received from the user terminal 4 (OP11: NO), the processing illustrated in FIG. 10 is ended.

Along with the storeroom use request, for example, information regarding the user, information regarding the user's belonging to be kept in the storeroom, information regarding the designated place for delivering the room unit 300, information regarding the planned start and end date/time for putting the user's belonging in, and the like are also received. Along with the rental room use request, for example, information regarding the user, information regarding the room unit 300 to be rented, information regarding the designated place for delivering the room unit 300, information regarding the planned start and end date/time for rental, and the like are also received.

In OP12, the control unit 11 acquires, from the vehicle management server 2, the information regarding the traveling unit 200 available on the planned start date/time. Specifically, the control unit 11 transmits, to the vehicle management server 2 via the server communication unit 12, an information acquisition request, the information regarding the user's belonging to be kept in the storeroom or the information regarding the room unit 300 to be rented, and the information regarding the planned start date/time for putting the user's belonging in or the information regarding the planned start date/time for rental. In response, the control unit 11 acquires the information regarding the available traveling unit 200 from the vehicle management server 2. For example, the available traveling unit 200 is the traveling unit 200 that has no schedule set at least on the planned start data/time for putting the user's belonging in or planned start date/time for rental, and is also capable of transporting the room unit 300 that can house the user's belonging to be kept in the storeroom or the room unit 300 that matches the desired condition of the user for the rental room.

In OP13, the control unit 11 acquires, from the storeroom management server 3, information regarding the room unit 300 that is available in a planned use time zone from the planned start date/time for putting the user's belonging in or for rental to the planned end date/time thereof. Specifically, the control unit 11 transmits, to the storeroom management server 3 via the server communication unit 12, the information acquisition request, the information regarding the user's belonging to be kept in the storeroom or the information regarding the room unit 300 to be rented, and the information regarding the planned start and end date/time for putting the user's belonging in or the information regarding the planned start and end date/time for rental. In response, the control unit 11 acquires the information regarding the room unit 300 available in the planned use time zone from the storeroom management server 3. For example, the room unit 300 available in the planned use time zone is the room unit 300 that has no schedule set from the planned start data/time to the planned end date/time for putting the user's belonging in or from the planned start data/time to the planned end date/time for rental, and is capable of housing the user's belonging to be kept in the storeroom or matches the desired condition of the user for the rental room.

In OP14, the control unit 11, in response to the use request, performs matching of the room unit 300 and the traveling unit 200. The matching is based on the information regarding the traveling unit 200 available on the planned start date/time for putting the user's belonging in or for rental acquired in OP12 and the information regarding the room unit 300 available in the planned use time zone acquired in OP13.

In OP15, the control unit 11 generates the schedule information. The schedule information includes, for example, the identification information of the user, the start and end date/time for putting the user's belonging in or for rental, the operation start date/time of the traveling unit 200, the information regarding the allotted room unit 300, the information regarding the allotted traveling unit 200, and the like.

In OP16, the control unit 11 transmits the generated schedule information to the user terminal 4 as a response to the use request. Further, the control unit 11 transmits the generated schedule also to the vehicle management server 2 and the storeroom management server 3. Thereafter, the processing illustrated in FIG. 10 is ended.

FIG. 11 is a flowchart of the processing of the center server 1 when delivering the room unit 300. The processing illustrated in FIG. 11 is executed repeatedly in a predetermined period, for example. The processing illustrated in FIG. 11 is executed for each entry of the schedule information table in the schedule information DB 14. In the explanation of FIG. 11 and thereafter, a subject schedule means the schedule indicated by the entry of the schedule information table that is the subject of the processing of FIG. 11.

In OP21, the control unit 11 determines whether or not it has reached the operation start date/time of the subject schedule. When it has reached the operation start date/time (OP21: YES), the processing proceeds to OP22. When it has not reached the operation start date/time (OP21: NO), the processing illustrated in FIG. 11 is ended.

In OP22, the control unit 11 generates operation plan information of the traveling unit 200 to which the subject schedule is allotted. The operation plan information includes instructions to, for example, (1) move the traveling unit 200 to the location of the room unit 300 to which the subject schedule is allotted, (2) connect to the room unit 300 when arrived, (3) move to the designated place by the user on the subject schedule while being connected to the room unit 300, and (4) separate the room unit 300 at the designated place by the user.

In OP23, the control unit 11 transmits a delivery start instruction to the vehicle management server 2 via the server communication unit 12. Along with the delivery start instruction, for example, the identification information of the subject schedule and the operation plan information are also transmitted.

In OP24, the control unit 11 determines whether or not a delivery completion notification is received from the vehicle management server 2 via the server communication unit 12. Along with the delivery completion notification, the identification information of the subject schedule is also received. When the delivery completion notification is received from the vehicle management server 2 (OP24: YES), the processing proceeds to OP25. When the delivery completion notification is not received from the vehicle management server 2 (OP24: NO), the processing of OP24 is repeatedly executed. For example, if the delivery completion notification is not received from the vehicle management server 2 even after the planned start time on the subject schedule has passed, occurrence of an error may be detected and predetermined processing may be executed. The processing when the error occurs may be notifying the occurrence of error to the user terminal 4, checking the position of the traveling unit 200, and the like, for example.

In OP25, the control unit 11 gives an instruction to the vehicle management server 2 to release the traveling unit 200 via the server communication unit 12. The instruction for releasing the traveling unit 200 is given by transmitting the updated schedule information of the subject schedule, for example. The update of the schedule information of the subject schedule in OP25 is performed by deleting the identification information of the corresponding traveling unit 200 from the traveling unit ID for transport, for example. Upon receiving the instruction for releasing the traveling unit 200, the vehicle management server 2 gives an instruction to the corresponding traveling unit 200 to move to a predetermined position. Further, the vehicle management server 2 updates the schedule information table held by itself according to the received schedule information, for example. Thereafter, the processing illustrated in FIG. 11 is ended.

FIG. 12 is an example of a flowchart of the processing when the center server 1 receives a use end notification. The processing illustrated in FIG. 12 is repeatedly executed in a predetermined period, for example. The processing illustrated in FIG. 12 is executed for each entry of the schedule information table, for example.

In OP31, the control unit 11 determines whether or not a storeroom or rental room use end notification is received from the user terminal 4. When the storeroom or rental room use end notification is received from the user terminal 4 (OP31: YES), the processing proceeds to OP32. When the storeroom or rental room use end notification is not received from the user terminal 4 (OP31: NO), the processing illustrated in FIG. 12 is ended. Along with the storeroom or rental room use end notification, for example, identification information of the schedule information is also received.

In OP32, the control unit 11 acquires the information regarding the currently available traveling unit 200 from the vehicle management server 2. Specifically, the control unit 11 transmits, to the vehicle management server 2 via the server communication unit 12, an information acquisition request and the information regarding the user's belonging to be kept in the storeroom or the information regarding the room unit 300 to be rented. In response, the control unit 11 acquires the information regarding the currently available traveling unit 200 from the vehicle management server 2. For example, the currently available traveling unit 200 is the traveling unit 200 that has no schedule set at the current point and also can transport the room unit 300 that has been used as the storeroom or the rental room.

In OP33, the control unit 11 determines the traveling unit 200 that picks up the room unit 300 on the subject schedule based on the information regarding the traveling unit 200 acquired from the vehicle management server 2. In OP34, the control unit 11 generates the operation plan information of the traveling unit 200 determined in OP33. The generated operation plan information includes instructions to, for example, move to the location (designated place by the user) of the room unit 300 on the subject schedule, connect to the room unit 300, move to the return place of the room unit 300 while being connected to the room unit 300, and separate from the room unit 300 at the return place.

In OP35, the control unit 11 transmits, to the vehicle management server 2 via the server communication unit 12, a pickup instruction of the room unit 300 for the traveling unit 200 determined in OP33. Along with the pickup instruction of the room unit 300, the identification information of the schedule information, the identification information of the traveling unit 200 determined in OP33, and the operation plan information generated in OP34 are also transmitted. Upon receiving the pickup instruction of the room unit 300, the vehicle management server 2 controls the operation of the corresponding traveling unit 200 according to the received operation plan information.

In OP36, the control unit 11 determines whether or not a pickup completion notification is received from the vehicle management server 2 and the storeroom management server 3. The pickup completion notification is transmitted from the storeroom management server 3, when the room unit 300 on the subject schedule is returned to the return place, for example. Further, the pickup completion notification is transmitted from the vehicle management server 2, when the traveling unit 200 headed for picking up the room unit 300 on the subject schedule returns to the standby place designated by the vehicle management server 2, for example.

When the pickup completion notification is received from the vehicle management server 2 and the storeroom management server 3 (OP36: YES), the processing proceeds to OP37. When the pickup completion notification is not received from the vehicle management server 2 and the storeroom management server 3 (OP36: NO), the processing of OP36 is repeated.

In OP37, the control unit 11 calculates the usage fee of the room unit 300 charged to the user of the subject schedule. The usage fee of the room unit 300 is calculated based on the charge list set in advance, for example.

In OP38, the control unit 11 calculates, from the usage fee of the room unit 300 charged to the user on the subject schedule calculated in OP37, the pay for the transportation by the traveling unit 200 and the pay for providing the room unit 300, when the room unit 300 is used as the storeroom. When the room unit 300 is used as the rental room, the control unit 11 calculates, from the usage fee of the room unit 300 charged to the user of the subject schedule calculated in OP37, the pay for providing the user's belonging inside the room unit 300 in addition to the pay described above.

In OP39, the control unit 11 executes payment processing. In the payment processing, the control unit 11 transmits information on the charged amount of the usage fee of the room unit 300 for the user to a server of a credit card company to which the user of the subject schedule is registered, for example, to receive payment from the server. Further, from the payed fee, the pay for the transportation by the traveling unit 200 and the pay for providing the room unit 300 acquired in OP38 are payed to the vehicle management server 2 and the storeroom management server 3, respectively. When the room unit 300 is used as the rental room, the pay for providing the user's belonging is also payed to the providing user of the belonging housed in the room unit 300. The payment for the providing user of the belonging is done via the storeroom management server 3, for example. The control unit 11 may offset the pay for the providing user for providing the belonging against the usage fee charged to the providing user for using the room unit 300 as the storeroom to keep the belonging, for example. Thereafter, the processing illustrated in FIG. 12 is ended.

Note that the flowcharts illustrated in FIG. 10 to FIG. 12 are examples, and the processing of the center server 1 is not limited to those. The order of the processing may be changed or the processing may be added or canceled according to embodiments.

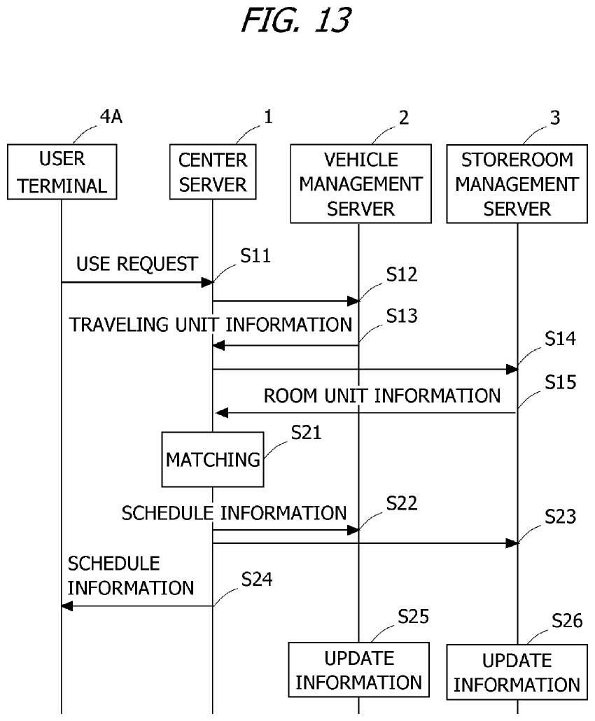

FIG. 13 is a chart illustrating an example of a sequence of the processing of the mobile rental-room providing system 100 from transmission of a use request of the room unit 300 from the user terminal until generation of a schedule for providing the room unit 300. In FIG. 13, it is assumed that there is a rental room use request for the room unit 300.

In S11, a user terminal 4A transmits a rental room use request to the center server 1. For example, in the user terminal 4A, an application for receiving the service of the mobile rental-room providing system 100 is installed. Upon receiving input of a user operation on the application, the user terminal 4A transmits a rental room use request. The center server 1 receives the rental room use request from the user terminal 4A (FIG. 10, OP11: YES).

Along with the rental room use request transmitted from the user terminal 4A in S11, information regarding the user of the user terminal 4A, information regarding the room unit 300 to be rented, information regarding the planned start and end date/time for rental, and information regarding the designated place for delivering the room unit 300 are also received. In S11, it is assumed that the information regarding the room unit 300 to be rented includes that a desired condition of the user for the rental room is to have a piano provided therein. That is, it is assumed that the rental room use request transmitted from the user terminal 4A in S11 is the rental room use request for the room unit 300 as a lesson room for the piano.

In S12, the center server 1 transmits an information acquisition request regarding the available traveling unit 200 to the vehicle management server 2 (FIG. 10, OP12). Along with the information acquisition request, information regarding the planned start date/time for rental and the fact that the room unit 300 to be rented is the lesson room for the piano (information regarding the room unit 300 to be rented) are also transmitted to the vehicle management server 2.

In S13, the vehicle management server 2 receives the information acquisition request and the like from the center server 1, and transmits the information regarding the available traveling unit 200 to the center server 1. The traveling unit 200 whose information is transmitted to the center server 1 in S13 is the traveling unit 200 that can load the room unit 300 to be the lesson room of the piano and has no schedule set on the planned start date/time for rental.

In S14, the center server 1 transmits the information acquisition request regarding the available room unit 300 to the storeroom management server 3 (FIG. 10, OP13). Along with the information acquisition request, the information regarding the planned start and end date/time for rental and the fact that the room unit 300 to be rented is the lesson room for the piano (information regarding the room unit 300 to be rented) are also transmitted to the storeroom management server 3.

In S15, the storeroom management server 3 receives the information acquisition request and the like from the center server 1, and transmits the information regarding the available room unit 300 to the center server 1. The room unit 300 whose information is transmitted to the center server 1 in S15 is the room unit 300 that is to be the lesson room for the piano and has no schedule set during the time from the planned start date/time for rental to the planned end date/time for rental.

In S21, the center server 1 performs matching of the traveling unit 200 and the room unit 300 to be delivered to the designated place of the user terminal 4A based on the information regarding the available traveling unit 200 and the information regarding the available room unit 300 (FIG. 10, OP14). Hereinafter, the matched traveling unit 200 is expressed as the traveling unit 200A. Further, the matched room unit 300 is expressed as the room unit 300A.

Thereafter, the center server 1 generates the schedule information (FIG. 10, OP15), and transmits the schedule information to the vehicle management server 2 (S22), the storeroom management server 3 (S23), and the user terminal 4A (S24). The schedule information includes, for example, the identification information of the schedule information, the identification information of the user of the user terminal 4A, the information regarding the planned start and end date/time for rental, the information regarding the date/time at which the traveling unit 200A starts the operation, the fact that the room unit 300 is used as the rental room, and the identification information of the traveling unit 200A and the room unit 300A (see FIG. 9).

In S25 and S26, the vehicle management server 2 and the storeroom management server 3 register the received schedule information to the schedule information table, respectively.

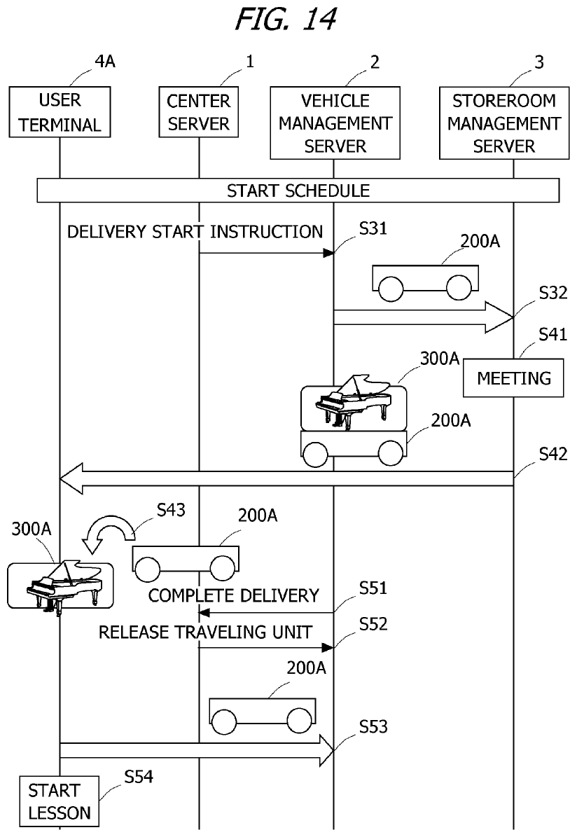

FIG. 14 is a chart illustrating a sequence of the processing when delivering the room unit 300A to the designated place of the user. FIG. 14 is the processing continued from FIG. 13. In S31, upon turning to the operation start date/time of the subject schedule (FIG. 11, OP21: YES), the center server 1 generates the operation plan information of the traveling unit 200A (FIG. 11, OP22), and transmits a delivery start instruction and the generated operation plan information to the vehicle management server 2 (FIG. 11, OP23).

The operation plan information generated in S31 includes instructions for the traveling unit 200A to, for example, move to the location of the room unit 300A, connect to the room unit 300A, move to the designated place of the user on the subject schedule while being connected to the room unit 300A, and separate from the room unit 300A at the designated place by the user.

In S32, upon receiving the delivery start instruction from the center server 1, the vehicle management server 2 starts to control the operation of the traveling unit 200A according to the operation plan information received along with the delivery start instruction. First, the vehicle management server 2 transmits an instruction to the traveling unit 200A to move to the location of the room unit 300A. Upon receiving the instruction from the vehicle management server 2, the traveling unit 200A starts to move to the location of the room unit 300A. The vehicle management server 2 communicates with the traveling unit 200A, and controls the operation of the traveling unit 200A while monitoring the position of the traveling unit 200A.

In S41, the traveling unit 200A arrives at the location of the room unit 300A so that the traveling unit 200A meets the room unit 300A. The vehicle management server 2 transmits an instruction to the traveling unit 200A to connect to the room unit 300A. Upon receiving the instruction from the vehicle management server 2, the traveling unit 200A connects to the room unit 300A. In S42, the vehicle management server 2 transmits an instruction to the traveling unit 200A to move to the designated place of the user. Upon receiving the instruction from the vehicle management server 2, the traveling unit 200A moves to the designated place by the user terminal 4A while being connected to the room unit 300A.

In S43, the traveling unit 200A arrives at the designated place by the user. The vehicle management server 2 transmits an instruction to the traveling unit 200A to separate from the room unit 300A. Upon receiving the instruction from the vehicle management server 2, the traveling unit 200A separates and sets the room unit 300A at the designated place by the user.

In S51, the vehicle management server 2 detects that the traveling unit 200A and the room unit 300A are separated, and transmits a delivery completion notification to the center server 1. The fact that the traveling unit 200A is separated from the room unit 300A may be detected by a notification from the traveling unit 200A or may be notified by the traveling unit 200A by an input operation of the user of the user terminal 4A made via the input apparatus provided to the traveling unit 200A, for example.

In S52, the center server 1 receives the delivery completion notification from the vehicle management server 2 (FIG. 11, OP24: YES), and transmits a release instruction of the traveling unit 200A to the vehicle management server 2 (FIG. 11, OP25). For example, the release instruction of the traveling unit 200A may be transmitted by transmitting the schedule information of the subject schedule from which the traveling unit 200A as the traveling unit for transport is deleted.

In S53, upon receiving the release instruction of the traveling unit 200A from the center server 1, the vehicle management server 2 gives an instruction to the traveling unit 200A to move to a predetermined place. The predetermined place may be anyplace such as a standby place of the traveling unit 200A, the initial position, or the like. Upon receiving the instruction from the vehicle management server 2, the traveling unit 200A moves to the predetermined position. In S54, the user of the user terminal 4A starts a piano lesson in the room unit 300A.

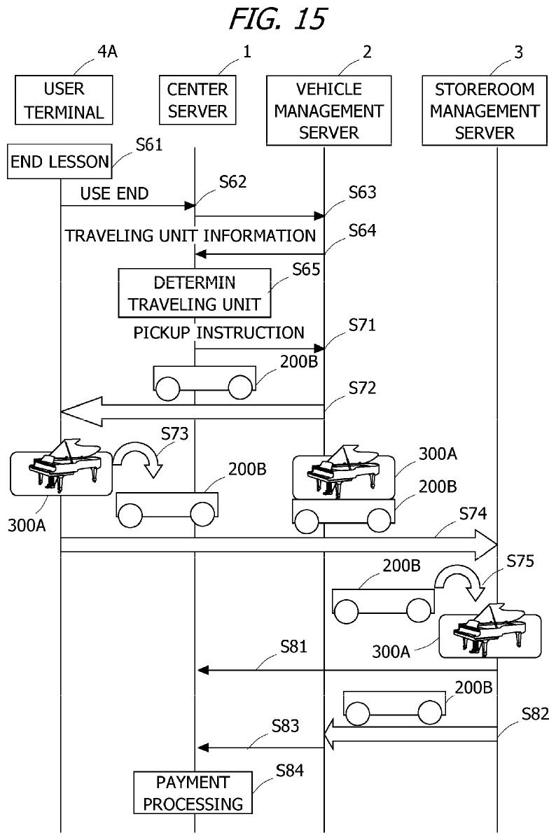

FIG. 15 is a chart illustrating an example of a sequence of pickup processing of the room unit 300A executed in the mobile rental-room providing system 100. The processing illustrated in FIG. 15 is continued from FIG. 14.

In S61, the user of the user terminal 4A ends the use of the room unit 300A as the lesson room. In S62, upon receiving an operation input from the user, for example, the user terminal 4A transmits a use end notification of the room unit 300A to the center server 1. The center server 1 receives the use end notification of the room unit 300A from the user terminal 4A (FIG. 12, OP31: YES).

In S63, the center server 1 transmits, to the vehicle management server 2, an information acquisition request regarding the currently available traveling unit 200. Along with the information acquisition request, the information regarding the room unit 300A used on the subject schedule is also transmitted.

In S64, upon receiving the information acquisition request regarding the currently available traveling unit 200 from the center server 1, the vehicle management server 2 transmits the information regarding the currently available traveling unit 200 to the center server 1. The center server 1 acquires the information regarding the currently available traveling unit 200 (FIG. 12, OP32).

In S65, the center server 1 determines the traveling unit 200 for picking up the room unit 300A based on the information regarding the currently available traveling unit 200 (FIG. 12, OP33). The traveling unit 200 for picking up the room unit 300A determined in S65 will be expressed as the traveling unit 200B hereinafter. Note that the traveling unit 200 for recovering the room unit 300A may also be the traveling unit 200A that has delivered the room unit 300A.

In S71, the center server 1 transmits a pickup instruction of the room unit 300A to the vehicle management server 2 (FIG. 12, OP35). Along with the pickup instruction of the room unit 300A, operation plan information of the traveling unit 200B is also transmitted. The operation plan information transmitted to the vehicle management server 2 in S66 includes instructions for the traveling unit 200A to, for example, move to the designated place of the user, connect to the room unit 300A at the designated place, move to the return place of the room unit 300A while being connected to the room unit 300A, and separate from the room unit 300A at the return place of the room unit 300A.

In S72, upon receiving the pickup instruction of the room unit 300A from the center server 1, the vehicle management server 2 starts to control the operation of the traveling unit 200B according to the operation plan information received from the center server 1. First, the vehicle management server 2 transmits an instruction to the traveling unit 200B to move to the designated place of the user. Upon receiving the instruction from the vehicle management server 2, the traveling unit 200B moves to the designated place of the user where the room unit 300A is at.

In S73, the traveling unit 200B arrives at the designated place by the user terminal 4A. Upon detecting that the traveling unit 200B has arrived at the designated place by the user terminal 4A, the vehicle management server 2 transmits an instruction to the traveling unit 200B to connect to the room unit 300A. Upon receiving the instruction from the vehicle management server 2, the traveling unit 200B connects to the room unit 300A.

In S74, the vehicle management server 2 transmits, to the traveling unit 200B connected to the room unit 300A, an instruction to move to the return place of the room unit 300A. Upon receiving the instruction from the vehicle management server 2, the traveling unit 200B moves to the return place of the room unit 300A while being connected to the room unit 300A.

In S75, the traveling unit 200B arrives at the return place of the room unit 300A, and it is detected by the vehicle management server 2. The vehicle management server 2 transmits an instruction to the traveling unit 200B to separate from the room unit 300A. Upon receiving the instruction from the vehicle management server 2, the traveling unit 200B separates from the room unit 300A. Thereby, the room unit 300A is brought down from the traveling unit 200B.

In S81, the storeroom management server 3 transmits a pickup completion notification to the center server 1. For example, the storeroom management server 3 detects that the room unit 300A is returned by a sensor provided at the return place or by an operation of a predetermined terminal by a staff member.

In S82, the vehicle management server 2 gives an instruction to the traveling unit 200B to move to a predetermined place. The move of the traveling unit 200B in S82 is not included in the operation plan information from the center server 1, for example, and may be done by the control of the vehicle management server 2.

In S83, the traveling unit 200B arrives at the predetermined place, and the vehicle management server 2 detects it and transmits a pickup completion notification to the center server 1. Thereby, the center server 1 receives the pickup completion notification of the room unit 300A from both the vehicle management server 2 and the storeroom management server 3 (FIG. 12, OP36: YES).

In S84, the center server 1 executes the payment processing for the usage of the room unit 300A as the rental room (FIG. 12, OP39). Specifically, the center server 1 first calculates the usage fee of the room unit 300A as the rental room charged to the user of the user terminal 4 (FIG. 12, OP37). Then, the pays for the traveling units 200A, 200B, the room unit 300A, and the piano in the room unit 300A payed from the usage fee of the room unit 300A as the rental room are calculated (FIG. 12, OP38). The center server 1 executes the payment processing for each of the predetermined servers (FIG. 12, OP39).

### <Effects of First Embodiment>

In the first embodiment, the room unit 300 functions as a storeroom for keeping equipment that is not being used by the first user and as a rental room for providing the equipment and the space within the room unit 300 to the second user. This makes it possible to effectively utilize the room unit 300. Further, since the equipment not being used by the first user can be used by another user, it is possible to effectively utilize the equipment not being used by the first user.

Further, when the room unit 300 functioning as the storeroom that houses the equipment kept therein is used as the rental room, the remuneration is also payed to the first user who is the owner of the equipment. The first user can make a profit with the equipment that is not being used. This makes it possible to promote providing the equipment as facilities in the rental room. Further, the remuneration for providing the equipment kept in the storeroom may be offset against the usage fee of the room unit 300 used as the storeroom. This makes it possible to promote the use of the room unit 300 as the storeroom.

In the first embodiment, the room unit 300 and the traveling unit 200 are connectable and separable. After delivering the room unit 300 to the designated place of the user who uses it as the rental room, the traveling unit 200 separates the room unit 300. Thereby, the traveling unit 200 becomes free when the room unit 300 is being used as the rental room by a user, so that the operating rate thereof can be improved by doing other work and the like. Further, the number of the traveling units 200 to be prepared can be suppressed less than the total number of the room units 300. This makes it possible to suppress the initial cost, since the traveling unit 200 is more expensive than the room unit 300.

Further, the piano, training machines, and the like are expensive and need to have some reasonable space, which may be obstacles to purchase one. By renting the room unit 300 having those provided therein as the rental space, the users who desire to use the piano, the training machines, and the like can use such equipment at a low cost when desired to use.

While the sequences of the processing when the room unit 300 is provided as the rental room are illustrated in FIG. 13 to FIG. 15, the sequences of the processing when the room unit 300 is provided as the storeroom are almost the same. However, when the room unit 300 is provided as the storeroom, there may be a case where it does not take a lot of time to put the user's belonging in the room unit 300. In such case, the traveling unit 200 that has transported the room unit 300 may stand by at that place and transport the room unit 300 to the return place after the user's belonging is put in. In such case, for example, the control unit 11 may determine whether or not to put the traveling unit 200 on standby after arriving at the designated place by the user based on the information regarding the planned start and end date/time for putting the user's belonging in, or the user may designate the traveling unit 200 to stand by. In such case, upon receiving a use end notification from the user terminal 4, the control unit 11 transmits, to the vehicle management server 2, a pickup instruction for the traveling unit 200. The processing thereafter is the same as the processing after S73 or S74 illustrated in FIG. 15. During the standby for putting the user's belonging in the room unit 300, the traveling unit 200 and the room unit 300 may remain connected or may be separated. Whether to remain connected or to be separated depends on the type of the user's belonging, the condition such as the designated place by the user, and the like.

### Other Embodiments

The embodiment described above is an example, and the present disclosure may be changed and carried out as appropriate without departing from the gist of the present disclosure.

In the first embodiment, the mobile rental-room providing system 100 includes the center server 1 to serve as a mediator with the user terminal 4, the vehicle management server 2 that manages the traveling unit 200, and the storeroom management server 3 that manages the room unit 300. However, the configuration of the mobile rental-room providing system 100 is not limited thereto. For example, there may be a case where the user who desires to use the room unit 300 as the rental room is not able to prepare the place to set the room unit 300. One of the examples for the place to set the room unit 300 may be a parking lot. Thus, the mobile rental-room providing system 100 may include a parking-lot management server that manages a coin-operated parking and the like to cooperate with the center server 1, and provide a parking lot for setting the room unit 300 to the user who uses the room unit 300.

Further, in the first embodiment, it is assumed that the traveling unit 200 is provided to the user by the mobile rental-room providing system 100. However, in a case where the user owns the traveling unit 200, the traveling unit 200 owned by the user may be used as well.

Further, in the first embodiment, it is assumed that the traveling unit 200 is an autonomous electrically driven vehicle, and the traveling unit 200 connects to the room unit 300 to form an autonomous drivable vehicle. However, the configuration is not limited to that. For example, the traveling unit 200 may be a towing vehicle (tractor) with a driver's seat, and the room unit 300 may be a container or a trailer.

The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus, comprising a processor configured to:
determine, when a use request is received from a second user for a room unit in which a first user stores at least one of the first user's belongings as a storeroom, a transport unit that connects to the room unit and transports the room unit to a designated place by the second user; and
cause the transport unit connected to the room unit to move to the designated place by the second user and to separate from the room unit at the designated place by the second user.

2. The information processing apparatus according to claim 1, wherein the processor is further configured to:
determine, when a use end notification of the room unit is received from the second user, a second transport unit that goes to the designated place by the second user to pick up the room unit; and
cause the second transport unit to move to the designated place by the second user, connect to the room unit at the designated place by the second user, move to a predetermined place after connected to the room unit, and separate from the room unit at the predetermined place.

3. The information processing apparatus according to claim 1, wherein the processor is further configured to:
calculate a usage fee of the room unit of the second user; and
allot, from the usage fee of the room unit, a pay for providing the room unit, a pay for transporting the room unit, and a pay for the first user for providing the at least one of the first user's belongings.

4. The information processing apparatus according to claim 3, wherein the processor is further configured to acquire a charged fee for the first user by subtracting the pay for providing at least one of the first user's belongings from the usage fee of the room unit as the storeroom charged to the first user.

5. The information processing apparatus according to claim 1, wherein the processor is further configured to:
determine, when a storeroom use request is received from the first user, the room unit to be delivered to a designated place by the first user and a third transport unit that connects to the room unit and transports the room unit to the designated place by the first user; and
cause the third transport unit connected to the room unit to move to the designated place by the first user.

6. The information processing apparatus according to claim 5, wherein the processor is further configured to cause the third transport unit to move to a predetermined place while being connected to the room unit, after the at least one of the first user's belongings is housed in the room unit at the designated place by the first user.

7. The information processing apparatus according to claim 5, wherein the processor is further configured to cause the third transport unit to separate the room unit at the designated place by the first user.

8. The information processing apparatus according to claim 7, wherein the processor is further configured to:
determines, when a housing end notification of the at least one of the first user's belongings is received from the first user, a fourth transport unit that goes to the designated place by the first user to pick up the room unit; and
cause the fourth transport unit to move to the designated place by the first user, connect to the room unit at the designated place by the first user, and move to a predetermined place after being connected to the room unit.

9. An information processing system, comprising a processor configured to:
determine, when a use request is received from a second user for a room unit in which a first user stores at least one of the first user's belongings as a storeroom, a transport unit that connects to the room unit and transports the room unit to a designated place by the second user; and
cause the transport unit connected to the room unit to move to the designated place by the second user and to separate from the room unit at the designated place by the second user.

10. The information processing system according to claim 9, wherein the processor is further configured to:
determine, when a use end notification of the room unit is received from the second user, a second transport unit that goes to the designated place by the second user to pick up the room unit; and
cause the second transport unit to move to the designated place by the second user, connect to the room unit at the designated place by the second user, move to a predetermined place after connected to the room unit, and separate from the room unit at the predetermined place.

11. The information processing system according to claim 9, wherein the processor is further configured to:
calculate a usage fee of the room unit of the second user; and
allot, from the usage fee of the room unit, a pay for providing the room unit, a pay for transporting the room unit, and a pay for the first user for providing the at least one of the first user's belongings.

12. The information processing system according to claim 11, wherein the processor is further configured to acquire a charged fee for the first user by subtracting the pay for providing at least one of the first user's belongings from the usage fee of the room unit as the storeroom charged to the first user.

13. The information processing system according to claim 9, wherein the processor is further configured to:
determine, when a storeroom use request is received from the first user, the room unit to be delivered to a designated place by the first user and a third transport unit that connects to the room unit and transports the room unit to the designated place by the first user; and
cause the third transport unit connected to the room unit to move to the designated place by the first user.

14. The information processing system according to claim 13, wherein the processor is further configured to cause the third transport unit to move to a predetermined place while being connected to the room unit, after the at least one of the first user's belongings is housed in the room unit at the designated place by the first user.

15. The information processing system according to claim 13, wherein the processor is further configured to cause the third transport unit to separate the room unit at the designated place by the first user.

16. The information processing system according to claim 15, wherein the processor is further configured to:
determines, when a housing end notification of the at least one of the first user's belongings is received from the first user, a fourth transport unit that goes to the designated place by the first user to pick up the room unit; and
cause the fourth transport unit to move to the designated place by the first user, connect to the room unit at the designated place by the first user, and move to a predetermined place after being connected to the room unit.

17. An information processing method executed by a computer, comprising:
determining, when a use request is received from a second user for a room unit in which a first user stores at least one of the first user's belongings as a storeroom, a transport unit that connects to the room unit and transports the room unit to a designated place by the second user; and
causing the transport unit connected to the room unit to move to the designated place by the second user and to separate from the room unit at the designated place by the second user.

18. The information processing method according to claim 17, further comprising:
determining, when a use end notification of the room unit is received from the second user, a second transport unit that goes to the designated place by the second user to pick up the room unit; and
causing the second transport unit to move to the designated place by the second user, connect to the room unit at the designated place by the second user, move to a predetermined place after connected to the room unit, and separate from the room unit at the predetermined place.

19. The information processing method according to claim 17, further comprising:
calculating a usage fee of the room unit of the second user; and
allotting, from the usage fee of the room unit, a pay for providing the room unit, a pay for transporting the room unit, and a pay for the first user for providing the at least one of the first user's belongings.

20. The information processing method according to claim 19, further comprising acquiring a charged fee for the first user by subtracting the pay for providing at least one of the first user's belongings from the usage fee of the room unit as the storeroom charged to the first user.
